(19) United States
(12) Patent Application Publication
(10) Pub. No.: US 2002/0091685 A1
(43) Pub. Date: Jul. 11, 2002

(54) System and method for filtering data events

(75) Inventors: Michael Feldman, (US); Hayim Salti, (US)

Correspondence Address: SHAHAN ISLAM, Esq., ROSENMAN & COLIN LLP, 575 Madison Avenue, New York, NY, 10022-2585, US

(73) Assignee: LetMeKnow Technology, Tel Aviv (IL)

(21) Appl. No.: 09/756,663

(22) Filed: Jan. 10, 2001

(51) Int. Cl. G06F 17/00

(52) U.S. Cl. 707/5

(57) ABSTRACT

A according to the present invention is provided a system and method for filtering incoming data events which are defined by data attributes according to generic rules defined by users, said rules containing combination of criterion for the data attributes. Each of the rules is converted to set of expressions, wherein each expression comprises a set of Boolean conditions. Said conditions are defined as true if the data attributes are falling within said criterion. Each incoming data event is tested according to said query by checking said Boolean conditions. Data events which satisfy all Boolean condition of at least one expression are reported to the users.

### FIELD OF THE INVENTION

The invention relates to a method and system of filtering data events out of incoming data information, building condition rules database structure and transferring new data events data from data publishers to end users, over a network.

### BACKGROUND OF THE INVENTION

For purposes of this disclosure by the term “network” is meant to include at least two communication terminal connected through a communication line which can be hardwired, or virtual, such as satellite, cellular or other wireless communications. Communication terminal can mean a personal computer, phone, fax or other similar-type of device capable of receiving, transmitting, and/or manipulating data for such purposes as, but not limited to.

Today methods and systems of filtering and notifying end user of new updated data events are inefficient. The amount of new emerging data in various fields e.g. daily news, brokers etc., are enormous. Private end users as well as business customers are no longer interested in all incoming data changes but in personalized areas. End user demand to be updated in data events matching specific criterion. For example, investors are not interested in being updated with all stock values but demand only essential data of stock relating to certain companies and matching specific range values.

The common solution is to maintain large database of all incoming updated data by service providers. Once an end user demands to be notified of relevant data, the service provider scans the updated databases, searching for relevant data matching specific criterion.

Such solutions occupy large amounts of computing and memory capacities, moreover the process of updating and scanning large database according to large number of user queries, cannot satisfy the demand for real time notification from numerous information sources.

A certain solution has been proposed in an attempt to overcome these deficiencies. Application No. EP0959416 (IBM application) refers to a mechanism for transforming the end users criterion into a database query problem. The basic approach of the IBM application is to invert the relationship of the data query process wherein the new data publication are treated as database data and end user requests are treated as database queries. According to conventional application of processing queries database, each new data record must be tested by all criterion of end users requests. Thus, although IBM solution improves the process of filtering incoming data event it is still inefficient when dealing with large data records and numerous end users requests

It is thus a prime object of the invention to avoid at least some of the limitations of the prior art and to provide a method and system of filtering data events, using minimum CPU and memory resources and reducing response process time.

### SUMMARY OF THE INVENTION

A method for filtering incoming events wherein each event is defined by at least one data attributes (“data event”) according to generic rules containing combination of criterion for the data attributes, said method comprising the steps of: Converting each of the rules to set of expressions, wherein each expression comprises a set of Boolean conditions, which are defined as true if the data attributes are falling within said criterion; Testing incoming data event according to at least one query within said set of queries by checking at least one of said Boolean conditions. (“Testing results”) and Selecting event out of the incoming events if all testing results of at least one query, are defined as true.

### BRIEF DESCRIPTION OF THE DRAWINGS

These and further features and advantages of the invention will become better understood in the light of the ensuing description of a preferred embodiment thereof, given by way of example only, with reference to the accompanying drawings, wherein-

FIG. 1 is a general schematic representation of the environment in which the present invention is practiced;

FIG. 2 is a scheme illustrating the process of managing new incoming data events according to the present invention;

FIG. 3 is a flow-chart, editing end user requests to set of queries according to the present invention;

FIG. 4 is a flow-chart, filtering new data event according to the present invention;

FIG. 5 is a flow-chart, checking data event relevancy according to the present invention;

### DETAILED DESCRIPTION OF THE PREFERRED EMBODIMENTS

The embodiments of the invention described herein are implemented as logical operations in a computing network system. The logical operations of the present invention are preferably presented (1) as a sequence of computer implemented steps running on the computing network system and (2) as interconnected machine modules within the computing network system. The implementation is a matter of choice dependent on the performance requirements of the computing network system implementing the invention. Accordingly, the logical operations making up the embodiments of the invention described herein are referred to variously as operations, steps, or modules.

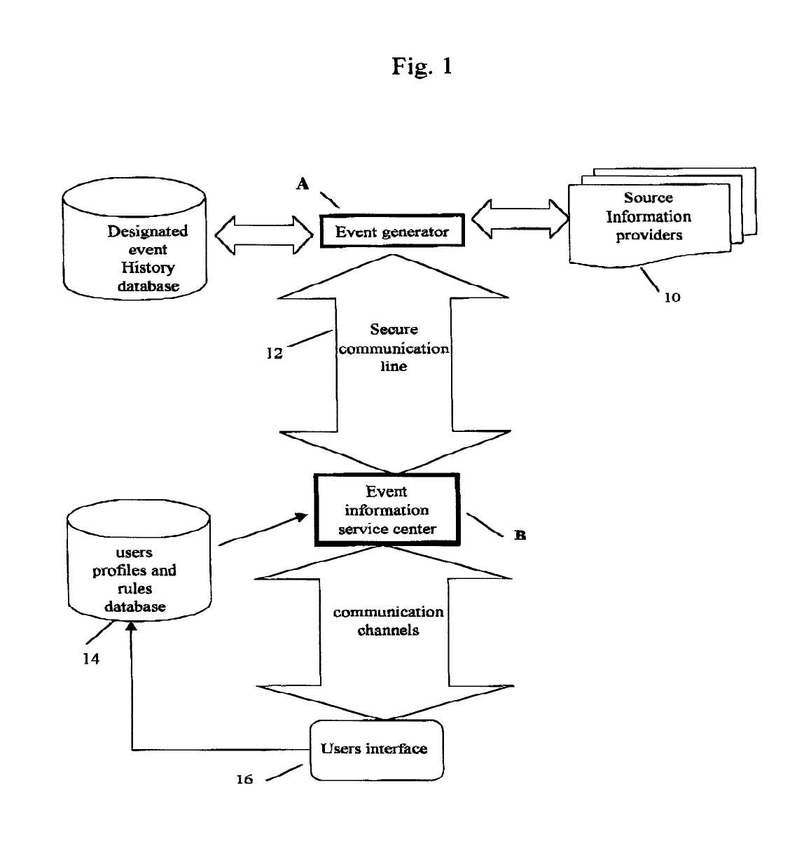

FIG. 1 illustrates the operating environment in which the present invention is used. As seen in FIG. 1 the information data is gathered from various information providers by an event generator service A. The produced data event is transferred through secure communication lines 12 to event information service B. the data event is analyzed and filtered by the event information services according to end users rules which are updated by the users and recorded in the Users database 14. Event data, matching the user rules, is transferred to respective end users through any communication channels 16 e.g. e-mails, cellular networks, fax etc.

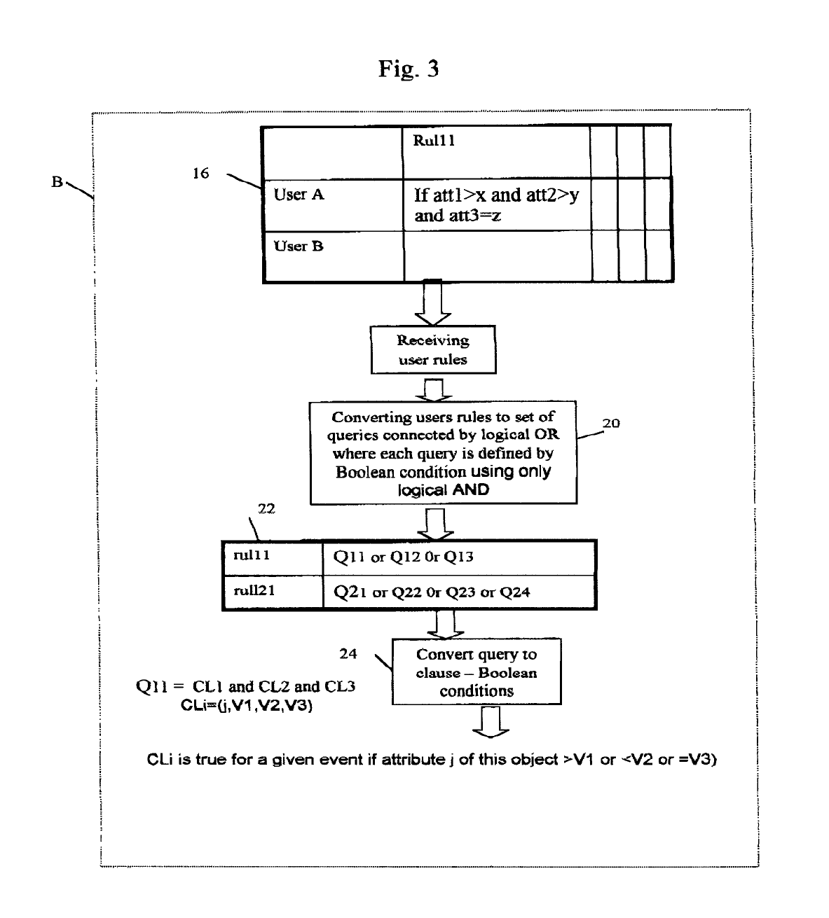

Let us assume that an end user demands to be updated with information according to rules. The rules can usually appear in the format as presented in FIG. 3. table 16. Each event-data object is defined by various attributes wherein each attribute has numerical or textual values. For example, if the event is a stock market, the stock is defined by the name of the issuing company, stock exchange market, stock value etc, the end user can define specific values or range of values. The end-user is informed of new data events just when a specific stock matches the defined values.

The end-users rules are analyzed and arranged as illustrated in FIG. 3. First (step 20), the rules are converted to set of queries. Different rules can comprise identical queries. The query refers to one or more attributes of event-objects. The queries (as illustrated in table 22) are connected by logical OR operators, each query defines one possible set of conditions, which satisfies the end-users rules. For example let us assume the end-user demands to be update every time a stock market of companies Y1 Y2 or Y3 exceeds value X1 or declines below value Y, these rules according to the present invention are converted to six queries, each query representing one possible option of each company stock to reach the defined range of values. One of the queries can be phrased by the following set of conditions: (if there is new data event relating company Y1) and (if the stock values exceeded value X1). Editing the queries as described above has a significant advantages: Once new data event satisfies one query the event is marked for delivery according to respective user rule, there is no need to check all other queries of rules defined by the respective end user for this event class.

Each query is defined by set of Boolean conditions (Clauses) connected by AND operators. Each clause represent one essential part of the end-user rules, in case one of conditions is false there is no need to check all other conditions of the same query. In the above example there are two Boolean conditions, the first one examines the first attribute of company stock, the second condition examines the stock's value.

Boolean conditions contain one or more range values (see FIG. 3 step 24). Each clause examines condition ranges, the examined data values must fit all of clause value ranges to satisfy the whole clause. Thus, each query is converted into a set of clauses connected by logical AND operators. All clauses must be true for query to be satisfied.

The re-organization of user rules by queries and clauses enables the acceleration of the computing process. According to further embodiment of the present invention the queries or clauses are tested simultaneously by using multiple computing processors. Hence, the processors are working in parallel enabling to test multiple queries and conditions at the same time.

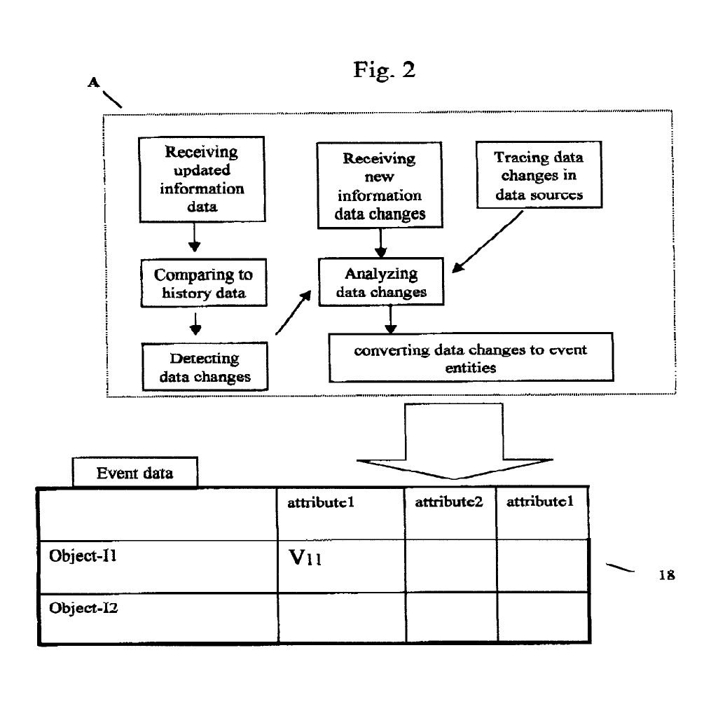

The end-User rules can refer not just to attributes of one event-object instance but to attributes of different event-object instances belonging to the same event class, attributes of different event-object instances of different event classes, or alternatively to history calculated event data gathered by the event generator A. FIG. 2 illustrates schematic mode of operation for generating data-events. Current updated information of new data streams from various information sources such as the stock market. As mentioned above end-users might demand to examine the data event not only by its current values but to compare the stocks values to history values. For example, history trends of stock values can be traced and recorded by the event generator A. Thus, when operating the relevant condition, event data whose current value exceeds from the “normal” trend of the stock values can be filtered out. Such filtering process provides the end users with “smart” alert systems, supporting the users with daily financial decisions.

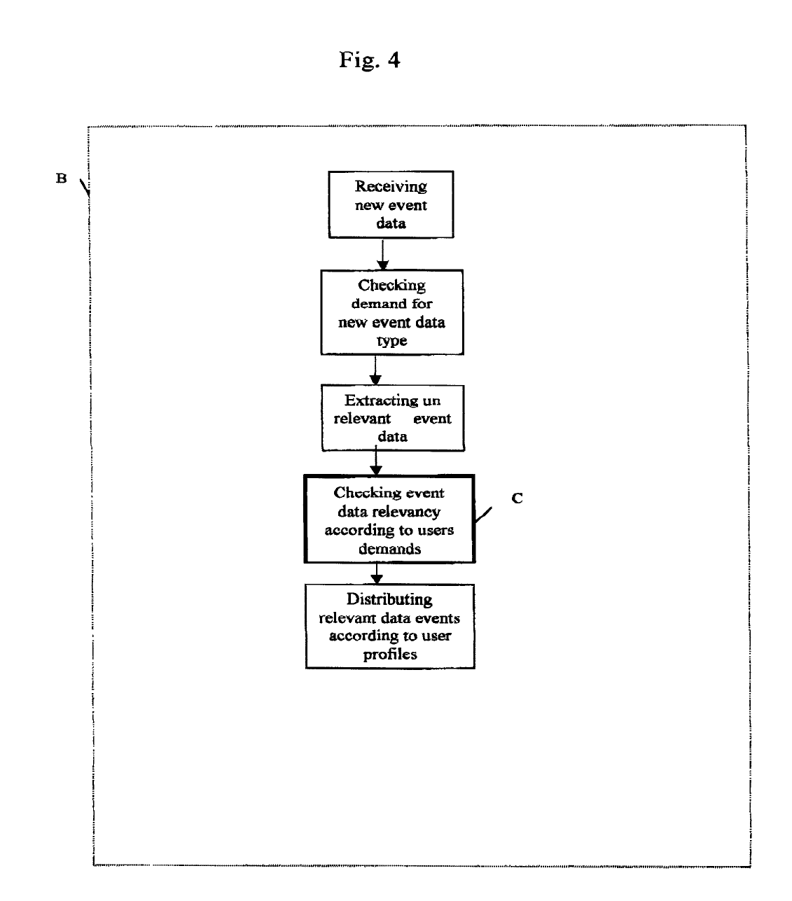

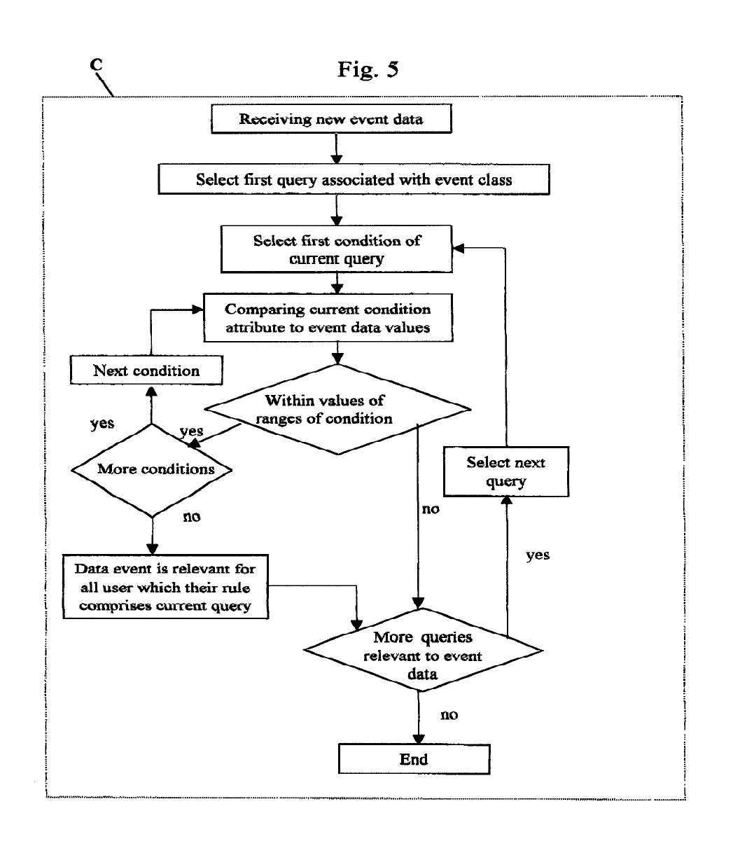

The process of examining the incoming event data is illustrated in FIG. 4. All incoming data event is first examined by its main subject, for example: in case data event of Israel stock market is processed, all main subjects of queries belonging to the event class are scanned, if no user has interest in the Israel stock market data, the said event data is extracted. The remained event data relevancy is checked according to the procedure illustrated in FIG. 5: each event attribute value is compared to range values of each condition-clause. If relevant attribute values are within the value range of all conditions of at least one query the data event is marked as relevant.

According to further embodiment of the present invention, it is suggested, to enable the end users to determine different weights to each query condition (as defined by clauses), wherein the weights reflect the condition's degree of relevancy. Alternatively, the user can determine weights to different rules, the weight are assigned to the respective queries or conditions at the conversion process. Thus when examining query relevancy, the relevancy is determined according to the total value of the weights of each satisfied clause, hence not all clauses must fully satisfied by the current event data values. Such method of filtering event data might be beneficial for newspaper events. For example, an end-user might be interested in all news relating to the Olympics games. When determining which news bulletins are relevant, the user rules can refer to words appearing in the news title summary or main text. According to the suggested method, the user can define weights for each word or phrase, thus the news relevancy is determined by total weights value of all relevant word or phrases.

According to another embodiment of the present invention, it is suggested, to enable the end users to determine rules which are depended on results of other rules relating the same event object or other event-objects. For example, an end-user might be interested in stock values of some new company just in case the stock values of its competitor declined bellow certain values.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method for filtering incoming events wherein each event is defined by at least one data attribute (“data event”) according to generic rules containing combination of criterion for the data attributes, said method comprising the steps of:
A. Converting each of the rules to set of expressions, wherein each expression comprises a set of Boolean conditions, which are defined as true if the data attributes are falling within said criterion;
B. Testing incoming data event according to at least one query within said set of queries by checking at least one of said Boolean conditions to yield at least one testing result; and
C. Selecting event out of the incoming events if all testing results of at least one query, are defined as true;

2. The method according to claim 1 wherein the criterion, queries or conditions are ranked by respective weight values so as to assign a rank for each said query criterion or criteria.

3. The method of claim 2 wherein selecting events out of the incoming events if testing results of at least one query is true and/or criterion total rank satisfies a certain level.

4. The method of claim 1 or 3 wherein testing incoming data event according to each query within said set of queries by checking each of said Boolean conditions. (“Testing results”)

5. The method of claim 1 or 3 wherein the set of rules are determined by at least one user.

6. The method of claim 1 wherein all relevant queries of each user are tested;

7. The method of claim 6 wherein each user defines personal details;

8. The method of claim 7 wherein the selected events are transferred to respective user according to said personal details.

9. The method of claim 1 wherein the testing procedure of different Boolean conditions is processed simultaneously by more then one computing units.

10. The method of claim 1 wherein the testing procedure of different queries is processed simultaneously by more then one computing units.

11. The method of claim 9 wherein the testing procedure of different conditions or queries is processed simultaneously by more then one computing units.

12. The method of claim 1 or 3 wherein plurality of different data events are processed simultaneously according to steps B and C.

13. A system for filtering incoming events wherein each event is defined by at least one data attributes (“data event”) according to generic rules containing combination of criterion for the data attributes, said system comprised of:
A. Means for Mathematical converting each of the rules to set of expressions, wherein each expression comprises a set of Boolean conditions, which are defined as true if the data attributes are falling within said criterion.
B. Memory means for storing all sets of expressions in one or more database in relation to user rules (“Expression database”).
C. Computing means for testing incoming data event by checking at least one of said Boolean conditions of at least one query within said set of queries to yield at least one testing result.
D. Classifying means for selecting events out of the incoming events in case all testing the results of at least one query, are defined as true.

14. The system according to claim 13 further comprising means for rating each criteria, query or condition by respective weight values so as to assign a rank for each sad query criterion or criteria;

15. The system of claim 14 wherein the classifying means selections of events out of the incoming events are determined by testing results of at least one query are defined as true and/or criterion total rank satisfies a certain level.

16. The system of claim 13 or 15 wherein the computing means test of incoming data event is performed to each query within said set of queries by checking each of said Boolean conditions (“Testing results”).

17. The system of claim 13 or 15 further comprising interface means enabling one or more users to determine the set of rules;

18. The system of claim 13 wherein the computing means tests all relevant queries of all users;

19. The system of claim 18 further comprising interface means enabling users to define personal details;

20. The system of claim 19 the further comprising communication means for transferring selected events to respective users according to defined personal details.

21. The system of claim 13 or 15 further comprising more than one computing means for processing simultaneous testing of different Boolean conditions;

22. The system of claim 13 or 15 further comprising more then one computing means for processing simultaneous testing of different queries;

23. The system of claim 13 further comprising more then one computing means for processing simultaneous testing of different conditions;

24. The system of claim 13 or 15 wherein plurality of different data events are processed simultaneously.
